(19) United States
(12) Patent Application Publication
(10) Pub. No.: US 2016/0096147 A1
(43) Pub. Date: Apr. 7, 2016

(54) POINT OF USE WATER FILTRATION SYSTEM

(71) Applicant: Frank Barton Smelley, Tuscaloosa, AL (US)

(72) Inventor: Frank Barton Smelley, Tuscaloosa, AL (US)

(21) Appl. No.: 14/873,159

(22) Filed: Oct. 1, 2015

Related U.S. Application Data
(60) Provisional application No. 62/058,732, filed on Oct. 2, 2014.

(51) Int. Cl. B01D 65/02; B01D 63/02; B01D 71/68; C02F 1/00

(52) U.S. Cl. CPC B01D 65/02; C02F 1/003; B01D 63/02; B01D 71/68; C02F 2303/04; C02F 2303/16; B01D 2321/04; B01D 2313/13

(57) ABSTRACT

A portable water filtration system and method for producing clean, safe drinking water from most readily available water supplies is provided. The portable water filtration system can be used in any location to produce clean drinking water without the need for a source of power. The system includes a filter made of polysulfone hollow fiber micro-tubes that is effective in filtering bacteria, protozoa, microorganisms, and other contaminants from unfiltered water sources. The system includes a connector for connecting the filter to a container holding unfiltered water via tubing. The connector has a built-in pre-filter that substantially reduces turbidity in unfiltered water in order to increase the efficiency of the filter, to extend the life of the filter, and to extend the amount of water that can be filtered between filter cleanings.

### CROSS REFERENCES

This application claims the benefit of U.S. Provisional Application No. 62/058,732, filed on Oct. 2, 2014, which application is incorporated herein by reference.

### FIELD OF THE INVENTION

A preferred embodiment of the invention refers to an apparatus and method for producing clean, safe drinking water from readily available water supplies and, more specifically, to a portable water filter system that can be used in any location to produce clean drinking water without the need for a power source.

### BACKGROUND

In many locations around the world, clean and safe drinking water is not readily or easily available. The lack of clean drinking water may simply be due to the remoteness of a particular location. Other times, natural disasters may cause a disruption in the drinking water supply in a particular location. However, often times the lack of clean drinking water is a chronic problem due to a deficiency in adequate water supply infrastructure in poorer nations. In fact, approximately one in eight people in the world do not have reliable access to clean drinking water. In many poor nations, residents regularly drink and bathe in water that contains many different types of bacteria and microorganisms. These contaminants can cause a wide range of health problems, including diarrhea, dysentery, and cholera, among others. These health conditions result in the deaths of thousands of people around the world every year and are easily preventable if clean drinking water were readily available to affected individuals.

One method for cleaning contaminated water to a level suitable for drinking is through filtration. However, there are many problems associated with currently available water filtration systems capable of producing clean drinking water. For instance, some filters known in the art are large and bulky and not easily portable to remote locations. Other known filters are complex and expensive to manufacture. Some filters are made of clay and are fragile, and thus break easily. Some require electricity that may not be available in remote, rural areas of developing countries.

Other problems with filters currently known in the art include the effectiveness of filtration. Ineffectiveness in filtration is typically caused by the turbidity of water from poor quality water sources, which are often the only sources available. For instance, water collected from rivers, streams, or wells often contain significant quantities of dirt and debris. The high turbidity of such water sources causes filters to clog very quickly, particularly filters having very small pores that are capable of filtering bacteria and microorganisms. In rural areas, and in particular arid rural areas, even rainwater tends to have very high turbidity due to the way rainwater is typically collected, which is normally through a series of gutters used to maximize rainwater collection. As the rainwater runs through gutters and over other surfaces during collection, the turbidity of the rainwater may increase significantly. This turbidity can clog filters to the point where the filter must be cleaned so often that its effectiveness is greatly diminished. Thus, such filters cannot consistently and effectively produce clean drinking water over an extended period of time without frequent cleanings. This is particularly a problem when numerous people are depending on a single water source in a location having a chronic shortage of clean drinking water.

Accordingly, a need exists in the art for a water filtration system that is portable and can be used to produce clean drinking water in any location around the world from any readily available water supply. In addition, a need exists in the art for a filter system that is simple in design, does not require a power source to operate, and is relatively inexpensive to manufacture. Furthermore, a need exists in the art for a filter system that is not prone to clogging and that can be easily cleaned and reused many times over an extended period of time.

### SUMMARY

A preferred embodiment of the invention is directed to a portable water filtration system that can be used in any location to produce clean drinking water without the need for a power source. Water is fed from an existing source through a conduit, which is preferably rubber tubing. The unfiltered water first passes through a turbidity reducing pre-filter to reduce the turbidity of low quality water by removing particulate matter or larger debris and then into a water filter cartridge, or shell, having a filter disposed therein. The filter preferably comprises polysulfone hollow fiber micro-tubes, which function as a semipermeable membrane filter. As the unfiltered water passes through the membrane filter housed within the filter cartridge, contaminants in the water are removed. The filter removes all bacteria, protozoa, and microorganisms larger than about 0.1 microns in diameter and about 99.9% of all bacteria, protozoa, and microorganisms from the water. These contaminants become trapped within the filter, resulting in clean, safe water for drinking and bathing.

The pre-filter is preferably made of stainless steel and is an important feature of the present invention. The pre-filter substantially increases the life of the hollow fiber membrane filter by significantly reducing the turbidity of the water before the water enters the filter cartridge. The pre-filter is disposed within a connector configured for connecting the filter cartridge to a container holding unfiltered water via a length of tubing. The connector comprises a male member and a female member. The male member is inserted into a hole in the side wall of the container and the female member is then threaded onto the male member to secure the connector to the container. The pre-filter is permanently attached to the female member so that water must always flow through the pre-filter in order to use the water filtration system.

Another preferred embodiment of the invention is directed to a kit for filtering water. The kit comprises the filter cartridge housing the hollow fiber membrane filter, tubing for interconnecting the filter cartridge with a container holding unfiltered water from an existing water source, a connector having a pre-filter disposed therein for connecting the tubing to the container, and a syringe for cleaning the filter that is housed within the cartridge. The kit preferably further comprises rubber gaskets, a hand-held drilling device, and an optional bracket for supporting the filter cartridge. A plastic bucket may also be supplied with the kit to serve as the container for holding the unfiltered water.

Another preferred embodiment of the invention is directed to a method of filtering water using the water filtration kit. Unfiltered water must first be supplied. The water may come from most readily available sources. The water source may include any type of freshwater such as rainwater or water from a well, river, or stream. The water is placed into a container that is interconnected to the filter cartridge by a length of tubing or other conduit. The container is preferably a plastic bucket. The hand-held drilling device is used to create a hole through the wall of the plastic bucket near the bottom of the bucket. The male member of the connector is inserted through the hole and the female member is then threaded onto the male member to secure the connector to the container. The rubber tubing is connected at one end to the connector and at the other end to the filter cartridge housing the hollow fiber membrane filter. The unfiltered water first flows through the pre-filter inside the connector in order to filter out particulate matter or other debris that may be present in the water. Thus, the pre-filter prevents clogging of the fiber membrane filter and prolongs the life of the filter. The unfiltered water then flows through the tubing and through the fiber membrane filter. The water that exits the filter is clean and safe for drinking, bathing, cooking, cleaning, etc. For the convenience of the user, the filter may be attached to the side of the bucket using the bracket provided in the kit.

Periodically, the filter housed within the cartridge will need to be cleaned. A syringe is provided for this purpose. Clean water that has already passed through the filter is used to fill the syringe. The cartridge is disconnected from the water source and the syringe is then connected to the discharge end of the cartridge and used to push water backward through the fiber membrane filter. The clean water moving backward through the filter will remove contaminants that have accumulated in the filter. The filter is then ready to be used again.

Accordingly, it is an object of the present invention to provide a water filtration system that is portable and can be used to produce clean drinking water in any location around the world from most readily available water supplies. In addition, another object of the present invention is to provide a filter system that is simple in design, does not require a power source to operate, and is relatively inexpensive to manufacture. Furthermore, yet another object of the present invention is to provide a filter system that is not prone to clogging and that can be reused many times over an extended period of time without the need for frequent cleaning. Another object of the present invention is to provide a connector having a pre-filter disposed within the connector so that water always flows through the pre-filter when using the water filtration system.

### DESCRIPTION OF THE DRAWINGS

These and other features, aspects, and advantages of the present invention will become better understood with regard to the following description, appended claims, and accompanying drawings where:

FIG. 1 depicts a side elevational view of a water filter cartridge embodying features of the present invention, with a section of the filter cartridge removed to show the interior of the filter.

FIG. 2 shows various elements of a water filter kit embodying features of the present invention.

FIG. 3 shows a front perspective view of a water filtration system embodying features of the present invention.

FIG. 4 shows a perspective view of a component of a water filtration system embodying features of the present invention.

FIG. 5 shows a perspective view of a component of a water filtration system embodying features of the present invention.

FIG. 6 shows a perspective view of a component of a water filtration system embodying features of the present invention.

### DETAILED DESCRIPTION

In the Summary above and in this Detailed Description, and the claims below, and in the accompanying drawings, reference is made to particular features, including method steps, of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with/or in the context of other particular aspects of the embodiments of the invention, and in the invention generally.

The term “comprises” and grammatical equivalents thereof are used herein to mean that other components, ingredients, steps, etc. are optionally present. For example, an article “comprising” components A, B, and C can contain only components A, B, and C, or can contain not only components A, B, and C, but also one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

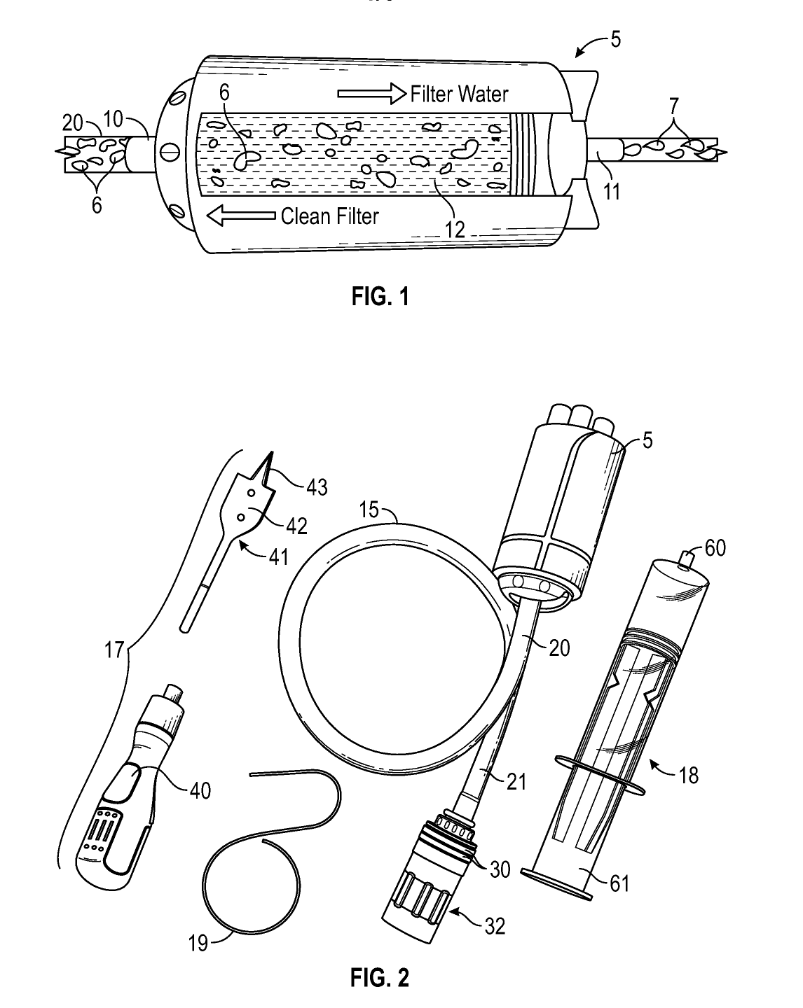

As illustrated in FIGS. 1-3, a preferred embodiment of the present invention is directed to a portable water filtration system that can be used in any location to produce clean drinking water from an existing water source without the need for a power source. The filtration system of the present invention comprises a filter cartridge 5 having a filter 12 disposed therein, which is preferably a hollow fiber membrane filter 12 that is capable of removing bacteria 6, protozoa 6, and microorganisms 6 larger than about 0.1 microns in diameter from the water and about 99.9% of all bacteria, protozoa, and microorganisms found in the water, thereby producing filtered water 7 suitable for drinking, cooking, and bathing.

The system further comprises a turbidity reducing pre-filter 16, which substantially extends the life of the filter 12 by preventing particulate matter and other debris commonly found in natural water sources from entering the filter 12. Unfiltered water first flows through the pre-filter 16 before flowing through the filter 12 housed within the filter cartridge 5. The pre-filter 16 is disposed within a connector 32, which connects the filter cartridge 5 to a container 50 via a length of tubing 15.

The filter cartridge 5 is small, lightweight, easy to transport, and simple to use. In addition, the membrane filter 12 is reliable, easy to clean, and will last for an extended period of time. The filter 12 is capable of producing at least 150 gallons of clean water each day, and each filter is capable of lasting up to ten years if used and cleaned properly.

As illustrated in FIG. 1, in a preferred embodiment, the filter cartridge 5 is generally cylindrical in shape. The cartridge 5 has a hard exterior, or shell, preferably made of hard plastic. The filter cartridge 5 further comprises a water inlet nozzle 10 and a water outlet nozzle 11 located at each end, respectively, of the cartridge. A filter 12 is disposed within the cartridge 5. The filter 12 preferably comprises polysulfone polymers 12, which provide the filtration of the water. The polymers 12 form hollow fiber micro-tubes having pore sizes of about 0.1 microns or less. Thus, bacteria 6, protozoa 6, microorganisms 6, and other contaminants 6 found in the water source having a diameter of about 0.1 microns or greater become trapped in the pores as the water passes through the filter 12. The unfiltered water containing various contaminants 6 enters the filter cartridge 5 through the water inlet nozzle 10. Filtered water 7 then exits through the outlet nozzle 11 leaving the contaminants 6 trapped in the filter 12. Once the filtered water 7 exits the filter cartridge 5, it is ready for use in drinking, cooking, bathing, etc.

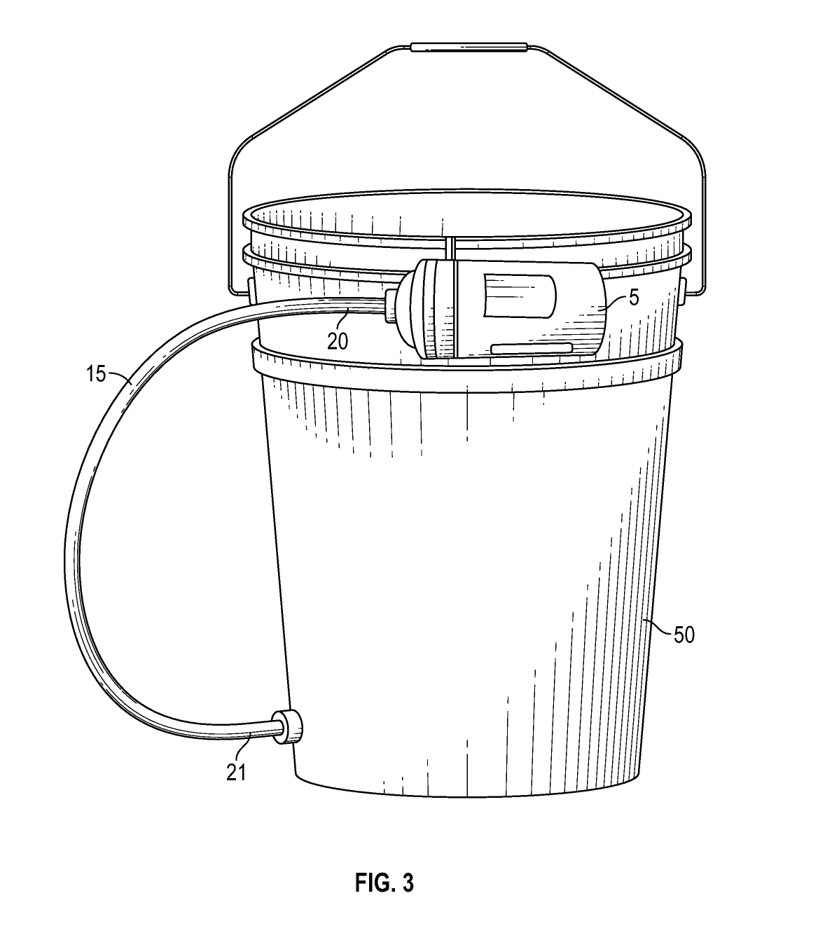

As illustrated in FIG. 2, in a preferred embodiment of the invention, the filter cartridge 5 is provided as part of a kit for filtering water. The kit comprises the filter cartridge 5 having a filter 12 disposed therein, tubing 15 for interconnecting the filter cartridge 5 with a container 50 holding unfiltered water from an existing water source, a connector 32 having a pre-filter 16 disposed therein, and a syringe 18 for cleaning the filter 12. The kit preferably further comprises rubber gaskets 30, a hand-held drilling device 17, and an optional bracket 19 for supporting the filter cartridge 5. As shown in FIG. 3, a plastic bucket 50 may also be supplied with the kit to serve as the container 50 for holding the unfiltered water.

In a preferred embodiment, the tubing 15 comprises rubber, but may also comprise plastic or any other material suitable for acting as a conduit for drinking water. The tubing 15 is preferably flexible, though the tubing 15 may comprise a rigid material such that the filter cartridge 5 is rigidly interconnected with the container 50.

As illustrated in FIGS. 2 and 3, the tubing 15 has two ends 20, 21. The first end 20 is connected to the water inlet nozzle 10 on the filter cartridge 5, and the second end 21 is connected to the connector 32. In a preferred embodiment, the rubber tubing 15 and the inlet nozzle 10 are sized such that the tubing 15 can be firmly secured to the nozzle 10 simply by sliding the tubing 15 onto the nozzle 10. However, the tubing may be connected to the nozzle in any suitable manner.

The connector 32 connects the second end 21 of the tubing 15 to the container 50 holding the unfiltered water. FIGS. 4-6 illustrate components of the connector 32 in accordance with a preferred embodiment. As illustrated in FIGS. 4-6, the connector 32 is made of hard plastic and comprises a male member 33 and a female member 34 such that the two members 33, 34 can be joined together to form the connector 32 as shown in FIG. 2.

As shown in FIG. 6, the male member 33 has a nozzle 38 at one end and external male threads 35 at the opposite end. The second end 21 of the tubing 15 is connected to the male member 33 by sliding the tubing 15 onto the nozzle 38, as illustrated in FIG. 6. Alternatively, the second end 21 of the tubing 15 may be permanently attached to the male member 33 of the connector 32.

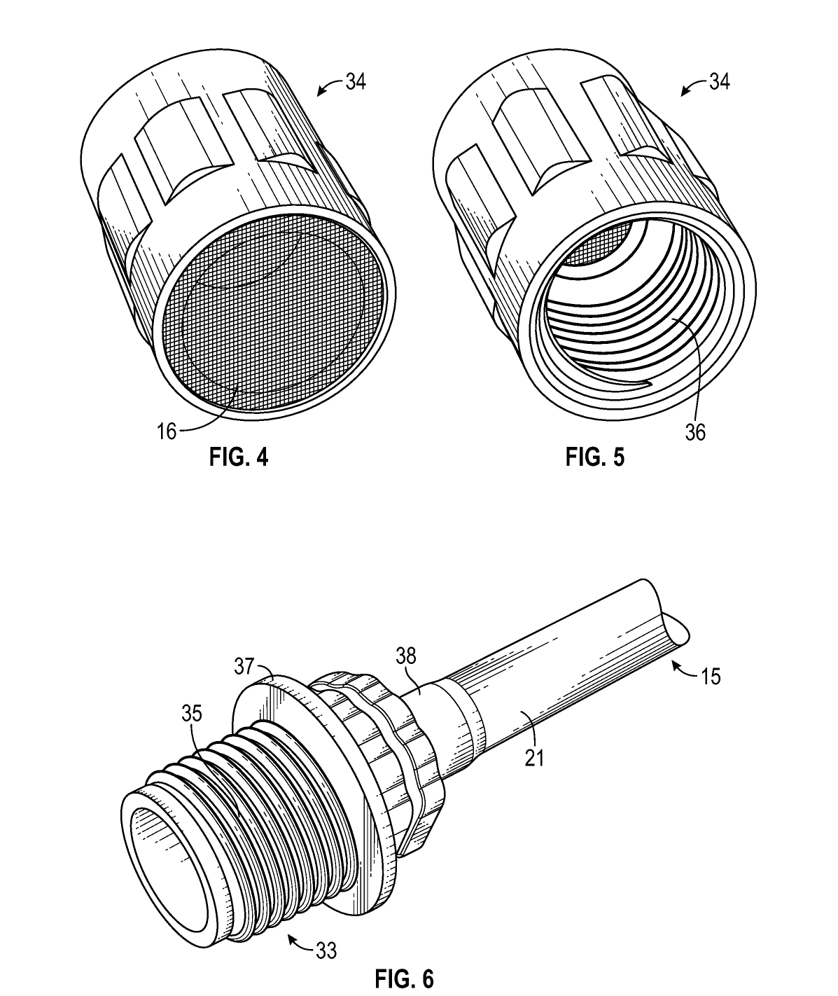

FIGS. 4-5 show perspective views of the female member 34 of the connector 32 from opposite ends. The female member 34 has female threads 36 at one end that are compatible with the male threads 35 of the male member 33 such that the male member 33 and the female member 34 can be threaded together to form the connector 32. As illustrated in FIGS. 4-5, the female member 34 further comprises a turbidity reducing filter screen 16 at the end opposite the female threads 36. The filter screen 16 is a pre-filter 16 for the filter 12 housed in the filter cartridge 5. As shown in FIGS. 4-6, each member 33, 34 has a longitudinal passageway extending therethrough such that the passageway extends continuously through the connector 32 when the male 33 and female 34 members are mated to each other by threading the members together.

The male member 33 of the connector 32 further comprises an annular element 37 attached to the exterior of the male member 33. As shown in FIG. 6, the annular element 37 is positioned around the circumference of the male member 33 and extends outward from the male member 33. The annular element 37 is positioned nearer to the end of the male member 33 having the nozzle 38 such that the male threads 35 are exposed for threading the male and female members 33, 34 together. The annular element 37 acts as a stopping mechanism for the male member 33 of the connector 32.

To connect the tubing 15 to the container 50 used to hold the unfiltered water, the threaded end 35 of the male member 33 is inserted into a hole extending through the side wall of the container 50. The hole in the wall of the container 50 is generally circular, and the radius of the annular element 37 is larger than the radius of the hole. Thus, the male member 33 of the connector 32 can only be inserted into the hole in the container 50 up to the point where the exterior of the wall of the container 50 comes into contact with the annular element 37. After the male member 33 of the connector 32 is inserted through the hole in the wall of the container 50 from the exterior of the container 50 (and before the container is filled with unfiltered water), the female member 34 is threaded onto the male member 33 from the interior of the container wall until both members 33, 34 are connected tightly to each other such that each member 33, 34 is pressed firmly against each side of the container wall. In this configuration, the two members 33, 34, which are now threaded together to form the connector 32, form a continuous passageway through the connector 32 such that the unfiltered water can flow from the inside of the container 50, through the connector 32, and into the tubing 15.

In a preferred embodiment, as illustrated in FIG. 2, the kit further comprises two generally circular gaskets 30, preferably made of rubber. Before the male and female members 33, 34 of the connector 32 are threaded together, each gasket 30 is positioned around the threads 35 of the male member 33 of the connector 32 on either side of the container wall, respectively. Once the male and female members 33, 34 are threaded together around the container wall, the rubber gaskets 30 will prevent any water from leaking from the container 50 around the hole in the container wall.

As illustrated in FIG. 4, the pre-filter 16 is incorporated into the female member 34 of the connector 32. The pre-filter 16 is attached to the female member 34 at the end opposite the female threads 36 such that unfiltered water must first flow through the pre-filter 16 before flowing into any other part of the system. The pre-filter 16 is attached to the female member 34 of the connector 32 such that it completely covers the opening to the continuous passageway extending through the connector 32 into the tubing 15. Thus, the unfiltered water must flow through the pre-filter 16 before flowing through the tubing 15 and ultimately the filter cartridge 5.

The connector 32 having a pre-filter 16 disposed therein is an important feature of the water filtration system because the pre-filter 16 reduces the turbidity of the water by preventing particulate matter suspended in unfiltered water from flowing through the filter 12. As previously discussed, high levels of turbidity are present in almost all water sources in rural areas, even collected rainwater. Other filters capable of removing significant quantities of bacteria and microorganisms are detrimentally affected by even relatively low levels of turbidity because these filters need to be cleaned with such a high frequency when filtering turbid water that the filters are rendered ineffective without some type of pre-filtering that significantly reduces turbidity. Other filtering materials could be used on site to reduce turbidity before filtering, but such materials are not always easily available or convenient to use. The connector 32 of the present invention comprises a built-in turbidity reducing pre-filter 16 such that the system cannot be used without the pre-filter 16. Thus, the pre-filter 16 is always readily available and convenient to use with the system. As a result, the pre-filter 16 substantially increases the efficiency of the filtration system and the life of the membrane filter 12, which is critical for applications in which the filtration system is used on a daily basis to filter water from poor quality sources.

The pre-filter 16 is preferably made of 100 US mesh stainless steel, which has openings that are approximately 150 microns, or about 0.0059 inches. In order to effectively reduce turbidity, it is preferred that the openings in the pre-filter 16 are not larger than about 150 microns. However, alternative embodiments of the invention may use a pre-filter have openings in the pre-filter 16 ranging from 50 to 200 microns. By using such a pre-filter 16, the turbidity will be substantially reduced, and the filter 12 will be utilized primarily for removing bacteria 6 and other microorganisms 6 and not for removing particulate matter. This will significantly increase the life of the filter 12 and significantly increase the amount of water that can be filtered between cleanings.

In a preferred embodiment, the kit further comprises a hand-held drilling device 17. The device comprises a handle 40 and a drilling attachment 41 connected to the handle 40. As shown in FIG. 2, the device 17 may come in two parts 40, 41 for ease of packaging and shipping the kit. The drilling attachment 41 is preferably made of a hard metal material that is suitable for manually drilling through the side of a plastic bucket 50 or other type of container used to hold water.

The distal end of the drilling attachment 41 comprises a flat metal element 42. The width of the metal element 42 is approximately the width of the desired radius of the hole to be drilled in the side of the plastic bucket 50. A sharp, pointed triangular element 43 extends outward from the distal end of the flat metal element 42. The point 43 is used to pierce a small hole in the side of the bucket 50. The user then rotates the handle 40 of the drilling device 17 while forcefully pushing the drilling attachment 41 into the side of the bucket 50. This action will cause the hole in the side of the bucket 50 to gradually increase in size until its radius is approximately equal to the width of the flat metal element 42. The plastic debris leftover from drilling the hole in the bucket 50 is then removed, and the container 50 is ready to be attached to the tubing 15 via the connector 32 described above.

The kit further comprises a syringe 18, preferably made of plastic. In a preferred embodiment, the volume of the syringe is about 60 milliliters. The purpose of the syringe 18 is for periodic cleaning of the membrane filter 12. The syringe 18 has a plunger 61 and an outlet nozzle 60, which is sized in order to be compatible with the water outlet nozzle 11 of the filter cartridge 5. When the filter 12 needs to be cleaned, the syringe outlet nozzle 60 can be easily and securely connected to the water outlet nozzle 11 on the filter cartridge 5 simply by inserting the syringe outlet nozzle 60 into the water outlet nozzle 11. The syringe 18 can then be used to backflush the membrane filter 12. The plunger 61 is pressed down to force clean water backward through the membrane filter 12, thereby removing contaminants that have accumulated within the filter over time.

In a preferred embodiment, the kit further comprises a bracket 19 for supporting the filter cartridge 5. The bracket 19 is preferably made of metal but may also be made of plastic or any other suitable material. The bracket 19 comprises a ring that fits around the exterior of the generally cylindrical filter cartridge 5 and securely supports the cartridge. The bracket 19 further comprises a hook that can be used to hang the filter cartridge 5 from any suitable structure. As shown in FIG. 3, the bracket 19 may be hooked to the top rim of a plastic bucket 50 that is used to hold the unfiltered water.

A preferred embodiment of the invention further comprises a method of filtering water using the kit described above. First, an existing source of unfiltered water must be provided. In addition, a container 50 for holding the unfiltered water must be provided, although such a container may optionally be provided as a part of the kit. The container is preferably a food grade plastic bucket 50.

Before adding the unfiltered water to the plastic bucket 50, a hole is drilled into the side wall of the bucket 50 using the hand-held drilling device 17 provided in the kit. The hole should be drilled near the bottom of the side wall of the bucket 50. The preferred location of the hole is approximately indicated in FIG. 3 at the location where the second end 21 of the tubing 15 is connected to the bucket 50 via the connector 32. In a preferred embodiment, the hole is drilled approximately one to two inches, and preferably about 1.5 inches, above the bottom of the bucket 50. The hole should preferably not be drilled at the very bottom of the side wall of the bucket or on the bottom of the bucket so that any larger debris that settles to the bottom of the bucket does not block the pre-filter 16 through which the water passes before entering the tubing 15. However, the hole should be drilled near the bottom of the bucket 50 so that when the bucket is filled with unfiltered water the water pressure in the bucket 50 helps to maintain a good flow rate through the filter 12. The water flows due to gravity and water pressure inside the bucket 50, which eliminates the need for a pump and thereby eliminates the need for a power source to operate the water filtration system. When filtering water, the filter cartridge 12 should be positioned at a point below the bucket 50 in order to achieve the maximum flow rate. The elimination of a requirement for a source of power is an important consideration in remote locations as well as poorer countries that may lack reliable electricity.

Alternatively, if the bucket 50 is included in the kit, it may have a pre-drilled hole at the proper location.

Once the hole is drilled in the proper location, the second end 21 of the tubing 15 is connected to the bucket 50 by inserting the threaded end 35 of the male member 33 of the connector 32 into the hole and threading the female member 34 onto the male member 33 (with the rubber gaskets 30 in place) until the connector 32 is tightly and securely attached to the side wall of the bucket 50. The first end 20 of the tubing 15 is then connected to the water inlet nozzle 10 on the filter cartridge 5 by sliding the end 20 of the tubing 15 onto the nozzle 10.

If desired, the filter cartridge 5 may be attached to a suitable structure using the bracket 19 provided in the kit, or simply attached to the side of the bucket 50 when not in use, as shown in FIG. 3.

The plastic bucket 50 may then be filled with unfiltered water. Water should then begin to flow due to gravity and water pressure at the pre-filter 16 located near the bottom of the bucket 50. Unfiltered water will first flow through the pre-filter 16 and the connector 32 and then into the tubing 15 and through the membrane filter 12. During periods of non-use, the water outlet nozzle 11 on the filter cartridge 5 may be fitted with a rubber cap. If so, the rubber cap is first removed to allow the water to flow through the filter cartridge 5. The water exiting the filter cartridge 5 through the outlet nozzle 11 will be clean and safe for use in drinking, bathing, cooking, cleaning, etc.

If the membrane filter 12 is properly used in conjunction with the pre-filter 16 as described above, the filter 12 should require cleaning no more than about once per week if used on a daily basis, or approximately after every 1,000 gallons of water filtered, depending on daily usage and levels of contaminants in the water. The filter 12 is cleaned by backflushing the filter 12. In order to backflush the filter 12, the tubing 15 is first disconnected from the water inlet nozzle 10 on the filter cartridge 5. The syringe 18 is then filled with clean, filtered water (i.e., water that is substantially free of contaminants), and the syringe outlet nozzle 60 is connected to the water outlet nozzle 11 on the filter cartridge 5. The plunger 61 on the syringe 18 is then forcefully pressed so that the clean water in the syringe 18 passes into the filter 12 through the normal water outlet nozzle 11 and is forced through the membrane filter 12 as fast as possible. The filtered water flows backward through the filter 12 and exits the filter cartridge 5 through the normal water inlet nozzle 10. When the filtered water flows backward through the filter 12, it removes contaminants trapped inside the filter 12. The arrows shown in FIG. 1 indicate the direction of flow for filtering and for backflushing. The backflushing process should be repeated about three or four times, or until the water being flushed through the filter 12 looks clear. The tubing 15 can then be re-connected to the water inlet nozzle 10 on the filter cartridge 5 and the filter 12 is again ready for use.

It is understood that versions of the invention may come in different forms and embodiments. Additionally, it is understood that one of skill in the art would appreciate these various forms and embodiments as falling within the scope of the invention as disclosed herein.

What is claimed is:

1. A connector for connecting tubing for a water filtration system to a container for holding unfiltered water, said connector comprising a male member and a female member, each member having a longitudinal passageway extending therethrough such that the passageway extends continuously through the connector when the male and female members are mated to each other, the male member having a nozzle at one end for connecting the tubing thereto and external male threads at the opposite end, the female member having compatible female threads at one end and a filter screen attached to the female member at the opposite end.

2. The connector of claim 1, wherein the filter screen has openings no larger than about 150 microns.

3. The connector of claim 1, wherein the male member further comprises an annular element attached to the exterior of the male member, said annular element being positioned around the circumference of the male member and extending outward from the male member.

4. A water filtration system, said system comprising a filter cartridge having a filter disposed therein, a length of tubing connected at one end to an inlet nozzle on the filter cartridge and at the other end to a connector for connecting the tubing to a container for holding water such that water can flow through the connector into the tubing, said connector having a pre-filter disposed therein such that water flows consecutively through the pre-filter, the tubing, and the filter cartridge, said pre-filter having openings no larger than about 150 microns.

5. The water filtration system of claim 4, wherein the filter disposed within the filter cartridge is a hollow fiber membrane filter.

6. The water filtration system of claim 5, wherein said hollow fiber membrane filter comprises polysulfone polymers.

7. The water filtration system of claim 5, said hollow fiber membrane filter having pore sizes of about 0.1 microns or smaller.

8. The water filtration system of claim 4, wherein said system removes about 99.9% of bacteria, protozoa, and microorganisms from an unfiltered water stream.

9. The water filtration system of claim 4, wherein said system is capable of producing at least about 150 gallons per day of filtered water.

10. The water filtration system of claim 4, said system further comprising a container for holding unfiltered water.

11. The water filtration system of claim 4, further comprising a drilling tool for forming a hole in a container for holding unfiltered water.

12. The water filtration system of claim 4, wherein a power source is not required to filter the water.

13. The water filtration system of claim 4, further comprising a syringe configured for backflushing the filter cartridge.

14. The water filtration system of claim 4, wherein the connector comprises a male member and a female member, each member having a longitudinal passageway extending therethrough such that the passageway extends continuously through the connector when the male and female members are mated to each other, the male member having a nozzle at one end for connecting the tubing thereto and external male threads at the opposite end, and the female member having compatible female threads at one end, wherein the pre-filter is attached to the female member at the opposite end.

15. A method of filtering water, said method comprising the following steps:
a. providing a filter cartridge having a filter disposed therein;
b. providing a length of tubing having a first end and a second end;
c. providing a connector configured for connecting the tubing to a container for holding water such that water can flow through the connector into the tubing, wherein the connector has a pre-filter disposed therein, said pre-filter having openings no larger than about 150 microns;
d. providing a container for holding unfiltered water;
e. connecting the first end of the tubing to the filter cartridge;
f. connecting the second end of the tubing to the connector;
g. connecting the connector to the container such that unfiltered water can flow consecutively from the container through the pre-filter, the tubing, and the filter cartridge;
h. forcing unfiltered water to flow from the container consecutively through the pre-filter, the tubing, and the filter cartridge, thereby producing filtered water.

16. The method of claim 15, wherein the connector comprises a male member and a female member, each member having a longitudinal passageway extending therethrough such that the passageway extends continuously through the connector when the male and female members are mated to each other, the male member having a nozzle at one end for connecting the tubing thereto and external male threads at the opposite end, and the female member having compatible female threads at one end, wherein the pre-filter is attached to the female member at the opposite end.

17. The method of claim 16, wherein the step of connecting the connector to the container comprises the steps of (1) forming a hole extending through the side wall of the container, (2) inserting the male member through the hole in the side wall of the container from the exterior of the container, and (3) threading the female member onto the male member.

18. The method of claim 15, wherein the filter disposed within the filter cartridge is capable of producing at least about 150 gallons per day of filtered water.

19. The method of claim 15, wherein the filter disposed within the filter cartridge is capable of removing about 99.9% of bacteria, protozoa, and microorganisms from an unfiltered water stream.

20. The method of claim 15, further comprising the step of flushing water substantially free of contaminants backward through the filter cartridge after approximately every 1,000 gallons of water filtered.
